(19) United States
(12) Patent Application Publication
(10) Pub. No.: US 2024/0150078 A1
(43) Pub. Date: May 9, 2024

(54) MULTILAYER PACKAGE ELEMENT, PACKAGE COMPRISING SUCH ELEMENT AND PROCESS FOR MAKING SUCH PACKAGE ELEMENT

(71) Applicant: PUSTERLA 1880 S.p.A., Milano (IT)

(72) Inventor: Roberto MARINI, Mantova (IT)

(21) Appl. No.: 18/504,563

(22) Filed: Nov. 8, 2023

(30) Foreign Application Priority Data
Nov. 9, 2022 (IT) 102022000023127

(51) Int. Cl. B65D 25/10; B32B 29/00; B65D 1/22; B65D 1/36; B65D 65/40

(52) U.S. Cl. CPC B65D 25/108; B32B 29/005; B65D 1/22; B65D 1/36; B65D 65/40; B32B 2250/26; B32B 2439/00; B65D 2203/00

(57) ABSTRACT

A package element for containing and exposing a product, having a seat shaped to accommodate a respective product, is described; the package element is obtained by forming a multilayer including paper plies made by a wet process, wherein the multilayer is formed by pressing in a mould at a temperature between 20° C. and 300° C.

### CROSS-REFERENCE TO RELATED APPLICATIONS

This application claims the benefit of Italian patent application 102022000023127, filed on 9 Nov. 2022, the disclosure of which is incorporated herein by reference in its entirety.

### TECHNICAL FIELD

The present disclosure relates to a package element for containing and exposing a product and a package comprising such package element.

The present disclosure also relates to a process for making a package element.

The present disclosure is usefully employed in the field of paper industry and, specifically, relates to packages, packaging, boxes, coated boxes, jewellery boxes, cases and/or the like for containing, exposing, and marketing various typologies of products.

The present disclosure particularly applies to packages for valuable and luxury products such as perfumes, creams, alcoholic products, high-quality cosmetic products, accessories and/or high-fashion articles, jewels and/or the like, but also to packages for food products such as for example trays sealed by plastic films.

### BACKGROUND

As known, presenting, and exposing, as well as marketing, valuable and luxury products require the use of equally valuable and high-quality packages, which are studied in greater detail.

For this purpose, packages of various shape and size which can be of the simple-type or foldable, coated by special materials, such as specific papers and/or canvas and/or any other valuable material, or screen-printed and/or planographically moulded, or provided with plastic elements being appropriately made by thermoforming processes, were made.

An example of known package commonly used for selling and/or for exposing perfumes, beauty products, alcohol and/or the like provides the presence of at least three elements, i.e., an outer box-shaped body, an housing element, adapted to receive in engagement the product to be contained and/or exposed, and a support inserted in the box-shaped body and adapted to support the housing element.

Particularly, the box-shaped body is provided with a bottom from which a plurality of side walls perpendicularly extends such as to define a respective housing compartment, in which the support is inserted. The housing element rests on the support and on the bottom of the box-shaped body and has one or more seats, or cavities, each shaped so as to accommodate a respective product. The support, which holds the housing element, has openings shaped similarly to the seats of the housing element for inserting them in the support.

In some known packages, the box-shaped body and the support are made of cardboard or of a similar paper material. Instead, the housing element is made of plastic, by an appropriate thermoforming process.

In order to visually cover most of the structure of the support and the housing element, and meanwhile allow the aesthetic decoration of the package, a decoration mask appropriately made of a valuable paper material is commonly glued on the same. The decoration mask covers the support and the housing element except for the seats, in such a way as to allow the placement or removal of the products to be contained and/or exposed. The decoration mask is thus provided, for each of the seats, with a respective through opening having the same shape.

In order to solve the problems due to the excessive use of plastic in the known packages, such as for example the issues related to waste recycling and disposing, as well as to costs for making plastic supports having configurations dedicated to particular combinations of products or articles to be contained and/or exposed, a package wherein the housing element is made of paper material, such as pressed cardboard pulp, thus entirely suppressing the use of plastic, has been ideated, as described in the Italian patent application no. 102016000068257 in the name of the same Applicant. Thereby, the package can be entirely recycled without needing to operate the separation of components made of materials other than paper material, such as plastic components.

However, the Applicant found that the packages entirely made of paper material are not free from drawbacks and are improvable in different aspects.

Indeed, the processes of processing and modelling the pressed cardboard pulp have more limits than the thermoforming processes adopted for making plastic housing elements.

Particularly, the process of making the housing element from cardboard pulp requires a drying step for removing water.

Disadvantageously, such drying step needs high temperatures, and this makes the process of making the housing element highly energy-consuming.

Making package elements by so-called “dry molding” processes is further known. Such processes are used for making package elements for food use, such as for example trays for cooked or pre-cooked food, glass covers for café products and so on.

Such processes are performed from a water-free cellulose raw material, obtained by compacting paper “fluff” (i.e., dried and grinded cellulose fibers to form a sort of wadding) in a plate shape.

Particularly, the package element is made by forming by pressing the plate-shaped raw material in a mould, thus imparting the shape of the mould to the same.

Disadvantageously, such process is not adapted to make package elements having complex shapes. Indeed, the above-described raw material, due to its nature, has been founded not to allow to follow the shape of the mould at detail elements having accentuated angles or being particularly small or fine, and thus is torn.

### SUMMARY

The present disclosure proposes a package element for containing and exposing a product, and a related package, capable of solving the problems found in the known art.
the present disclosure further provides a package element which is suitable to obtain even complex shapes, while maintaining its own structural integrity.

The present disclosure also provides a package adapted to contain and/or exhibit valuable and luxury products according to a predefined position, and a process for making a package element which allows to obtain package elements having even complex shapes.

The present disclosure reduces the environmental costs, both those related to plastic recycling, and the energy costs related to making package elements from cardboard pulp.

The above-mentioned and other advantages are substantially achieved by providing a package element, a package comprising such package element and a process for making a package element as set forth in the attached claims.

### BRIEF DESCRIPTION OF THE DRAWINGS

Further features and advantages will be more apparent from the description of preferred but non-exclusive embodiments of a package element, a package, and a process, illustrated for indicative and non-limiting purposes with the aid of the attached drawings in which:

FIGS. 1a and 1b schematically show two different steps of a process for making a package element according to the present disclosure;

FIG. 2 shows a package element according to the present disclosure;

FIG. 2a shows a section of a detail of the package element of FIG. 2;

FIG. 3 shows a perspective view of an embodiment of a package comprising a package element according to the present disclosure; and

FIG. 4 shows an exploded view of the package of FIG. 3.

### DETAILED DESCRIPTION OF THE DRAWINGS

With reference to the cited figures, a package element 1 for containing and exposing a product is described below.

In the following of the present description, package element 1 refers to the structural element of a package having a shape suitable to contain a determined product.

The package element 1 has at least one seat 2 shaped to accommodate a respective product.

The package element 1 according to the present disclosure can be applied for making packages for various fields, from valuable and luxury to food.

In the case of food packages, the package element 1 is realized for example by a tray for containing food.

In the case of packages for valuable and luxury products, the package element 1 corresponds to what is described above as the housing element, i.e., the package element adapted to receive in engagement a respective valuable and luxury product having a specific shape, such as a perfume or a cream.

Particularly in the case of packages for valuable and luxury products, optionally, the package element has two or more seats 2, each shaped to accommodate a respective product. The seats 2, and thus the products intended to be inserted therein, can have different shapes.

It should be noted that, according to the present disclosure, the package element 1 is obtained by forming a multilayer 10 comprising a plurality of paper plies 11. Particularly, the paper plies 11 are made by a wet process.

In other words, according to the present disclosure, the package element 1 is made from paper plies 11 based on cellulose pulp mixed with water, namely obtained by wet processes for making paper.

For example, the package element 1 can be made from a plurality of paper plies 11 such as those used for making toilet paper, kitchen paper, handkerchiefs, napkins.

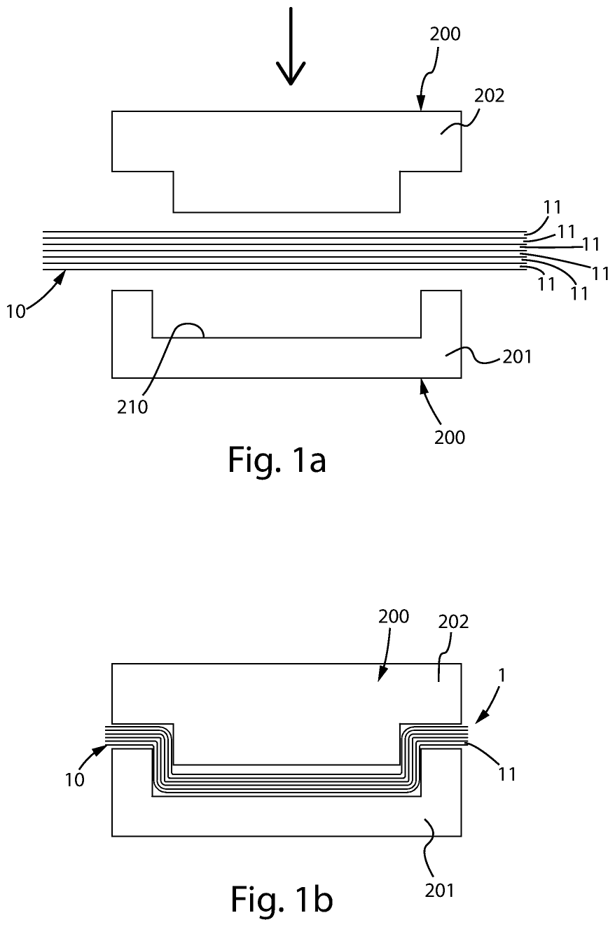

In detail, with reference to FIGS. 1a and 1b, the multilayer 10 is formed by pressing in a mould 200 at a temperature comprised between 20 and 300° C.

Advantageously, due to the presence of a plurality of paper plies 11, during the forming step in the mould 200 the paper plies 11 can slide with respect to each other, resulting in a structure capable of fitting in the shapes of the mould 200, thus preventing the formation of tears and defections and allowing to obtain a compact and intact package element 1.

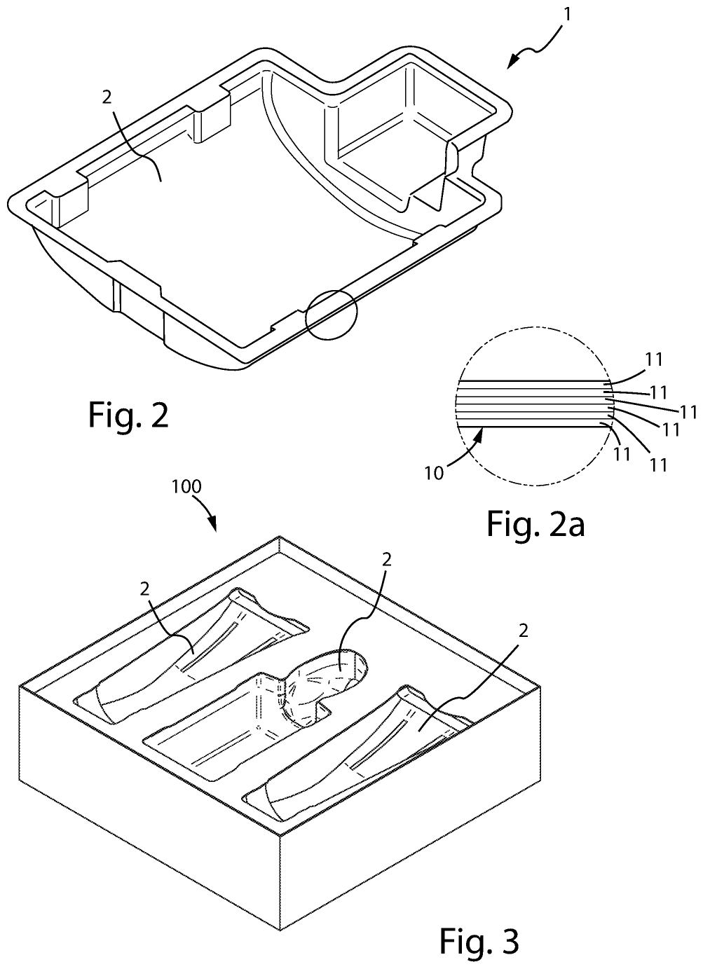

Advantageously, the multilayer 10 can be formed not only by simple shapes, but also by complex shapes, thus obtaining package elements 1 which can be used in various fields, from the food field using more simple shapes to the valuable and luxury field, requiring more complex shapes, as shown for example in FIG. 2.

It should be noted that, according to the present disclosure, preferably each paper ply 11 faces and is in direct contact by its own entire face with an adjacent paper ply 11. In other words, there are no elements or substances previously interposed between a paper ply 11 and the other in the multilayer 10.

Indeed, the paper plies 11 in the package element 1 which is formed in the mould 200 are held together with each other only by the pressure applied in the mould 200, without previously using glues.

Still preferably, the multilayer 10 comprises a number of paper plies 11 comprised between five and fifty.

More preferably, the number of paper plies 11 is comprised between five and ten.

Furthermore, preferably, each paper ply 11 has a grammage comprised between 10 and 80 g/m². More preferably, each paper ply 11 has a grammage comprised between 10 and 30 g/m².

Still preferably, the paper plies 11 of the multilayer 10 are equal to each other, partially or totally. For example, the paper plies 11 are provided with the same grammage, however falling within the range indicated above.

The paper plies 11 used for making a package element 1 according to the present disclosure can be subjected, before forming, to a step of humidifying by water and/or other additives. Thereby, the paper plies 11 used for making a package element 1 according to the present disclosure can comprise water and/or other additives. Such additives are those commonly used for making cellulose products, such as for example compounds of starch, gelatine, calcium, silicon, wax, colophony, AKD (alkyl ketene dimer), ASA (alkenyl succinic anhydride), and so on.

A package 100 comprising a package element 1 as described above forms also part of the present disclosure.

In the case of applications for food trays, not illustrated, the package 100 can comprise, in contact with the multilayer 10, i.e., with the paper plies 11, at least one outer barrier layer, for example adapted to contact the food product. The package 100 can also comprise a covering plastic film.

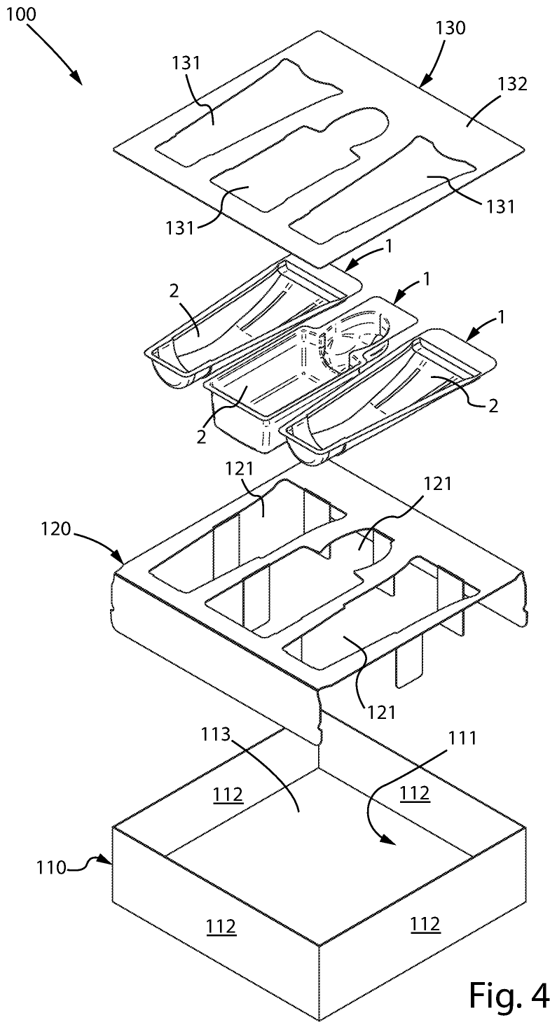

According to a preferred embodiment, as shown in FIGS. 3 and 4, the package 100 is a package for valuable and luxury products.

According to such embodiment, the package 100 comprises a box-shaped body 110 having a bottom 111 and at least one side wall 112 extending transversally from the bottom 111. Thereby, the bottom 111 and the side wall 112 delimit, at least partially, at least one housing compartment 113 open on the opposite side to the bottom 111. The box-shaped body 110 is preferably made of paper material.

The package 100 further comprises a supporting structure 120 made of a paper material, which can be inserted within the housing compartment 113 of the box-shaped body 110.

Particularly, in the package 100, the package element 1 is engaged with the supporting structure 120. According to such embodiment, the package 100 is adapted to contain and/or exhibit, according to a predefined position, a valuable and luxury product. Accordingly, the seat 2 of the package element 1 is shaped to accommodate a valuable and luxury product to be contained and/or exhibited according to a predefined position. The package 100 can also comprise multiple package elements 1 and/or multiple seats 2, each shaped so as to accommodate a respective valuable and luxury product.

The supporting structure 120, which holds the package element 1, has through openings 121 shaped similarly to the seats 2 of the housing element for inserting them in the support.

Optionally, the package 100 comprises a decoration mask 130. The decoration mask 130 is placed to cover the supporting structure 120 and the package element 1 except for the seats 2, in such a way as to allow the placement or removal of the products to be contained and/or exhibited. Therefore, the decoration mask 130 has through openings 131 having the same shape as the seats 2 and in the same number as the number of seats 2.

Preferably, the area defined by the shape of each of the through openings 131 is less than the area defined by the shape of the corresponding seat 2.

Particularly, each through opening 131 has the same shape of the corresponding seat 2. In other words, the shapes of the through openings 131 and those of the respective seats 2 have the same shape, but the areas defined by the shapes of the through openings 131 are less than those of the shapes of the corresponding seats 2 such that the product is retained by the decoration mask 130 within the seat 2.

Preferably, the decoration mask 130 has an exposed surface 132 apt to remain facing the opposite side from the bottom 111 of the box-shaped body 110 when the supporting structure 120 is inserted within the housing compartment 113.

Such exposed surface 132 can comprise an aesthetic decoration and/or a valuable surface finish.

Still preferably, the decoration mask 130 can be associated with the package element 1 and/or the supporting structure 120 by means of at least one gluing substance or a similar joining substance.

A process for making a package element 1 having a seat 2 shaped to accommodate a respective product forms also part of the present disclosure.

The process according to the present disclosure comprises a first step of providing a multilayer 10 of paper plies 11, where such paper plies 11 are made by a wet process.

The process thus comprises a step of arranging the multilayer 10 in a mould 200 having a predefined shape.

According to the present disclosure, such process further comprises a step of forming the multilayer 10 by pressing in the mould 200 at a temperature comprised between 20 and 300° C., in order to make a package element 1 having a seat having the predefined shape of the mould 200 and shaped to accommodate a respective product.

Preferably, the press is a 30-300-ton mechanical or hydraulic isostatic press. More preferably, the press is a 50-ton press.

It should be noted that the forming step can be performed at room temperature or by heating the mould 200.

Therefore, optionally, the process comprises a step of heating the mould 200 at a temperature comprised between 100° C. and 300° C.

The mould 200 is made of metal material such as for example steel or aluminium.

Generally, the mould 200 is composed by a female mould 201 having a cavity 210 having the predefined shape to be imparted to the multilayer 10. Furthermore, the mould 200 comprises a male mould 202 shaped complementarily to the female mould 201 and couplable to the female mould 201 for the forming step.

According to an embodiment, the male mould 202 comprises a removable piston (not illustrated) which is adapted to push the multilayer 10 in the cavity 210 of the respective female mould 201 in the forming step. Advantageously, the multilayer 10 can be adhered to the cavity 210 of the female mould 201 and the multilayer 10 can be formed accurately reproducing the predefined shape of the mould 200.

Preferably, the process comprises a step of humidifying the multilayer 10, performed prior to the forming step.

Still preferably, the step of humidifying the multilayer 10 is preferably performed in a humidifying station separate from the mould 200, in which water is vaporized.

Particularly, the step of humidifying the multilayer 10 is performed by supplying water to the multilayer 10 until reaching a humidity content in the multilayer 10 comprised between 30% and 50%. More preferably, the desired humidity content is 40%.

The step of humidifying the multilayer 10 can be performed by water or even additives adapted to facilitate the cohesion of the paper plies 11 to each other in the forming process.

In accordance, preferably the step of humidifying the multilayer 10 provides to supply water and/or additives to the multilayer 10.

Preferably, the process comprises, subsequently to the step of forming the multilayer 10, a step of cutting the multilayer 10, to contour the package element 1 according to a predetermined contour.

Thereby, a package element 1 suitable for use in a specific package 100 is obtained.

The package element, the package comprising such package element and the process for making a package element thus conceived are susceptible of a number of modifications and variations, all falling within the scope of the inventive concept.

Furthermore, all the details can be replaced by other technically equivalent elements.

In practice, the used materials, as long as compatible with the specific use, as well as the contingent shapes and size can be any depending on the requirements.

1. A package element for containing and exposing a product, having at least one seat shaped to accommodate a respective product; said package element being obtained by forming a multilayer comprising a plurality of paper plies made by a wet process, said multilayer being formed by pressing in a mould at a temperature comprised between 20° C. and 300° C.

2. The package element according to claim 1, wherein each paper ply faces and is in direct contact with the adjacent paper ply.

3. The package element according to claim 1, wherein said multilayer comprises a number of paper plies comprised between five and fifty.

4. The package element according to claim 1, wherein each paper ply has a grammage comprised between 10 and 80 g/m².

5. The package element according to claim 1, wherein the paper plies are equal to each other.

6. The package comprising a package element according to claim 1.

7. The package according to claim 6, comprising:
a box-shaped body having a bottom and at least one side wall extending transversally from the bottom; the bottom and the side wall delimiting, at least partially, at least one housing compartment open on the opposite side to the bottom;
a supporting structure made of a paper material, which can be inserted within said at least one housing compartment of the box-shaped body;
wherein
said package element is engaged with said supporting structure;
said package being adapted to contain and/or exhibit a valuable and luxury product according to a predefined position, said seat being shaped to accommodate a valuable and luxury product to be contained and/or exhibited according to a predefined position.

8. The package according to claim 7, comprising a decoration mask placed to cover the supporting structure and the package element except for the seats, such to allow the placement or removal of the products to be contained and/or exhibited; said decoration mask having through openings having the same shape as the seats and in the same number as the number of seats.

9. The package according to claim 8, wherein the area defined by said shape of each of said through openings is less than the area defined by the shape of the corresponding seat.

10. The package according to claim 8, wherein said decoration mask has an exposed surface apt to remain facing the opposite side from the bottom of the box-shaped body when the supporting structure is inserted within the housing compartment; said exposed surface comprising an aesthetic decoration and/or a valuable surface finish.

11. A process for making a package element having a seat shaped to accommodate a respective product, said process including the following steps:
providing a multilayer comprising a plurality of paper plies made by a wet process;
arranging the multilayer in a mould having a predefined shape; and
forming said multilayer by pressing in said mould at a temperature comprised between 20 and 300° C. in order to make a package element having a seat having said predefined shape and shaped to accommodate a respective product.

12. The process according to claim 11, comprising, prior to the step of forming the multilayer, a step of humidifying the multilayer by supplying water and/or additives to said multilayer.

13. The process according to claim 11, comprising, subsequently to the step of forming the multilayer, a step of cutting the multilayer in order to contour the package element according to a predetermined contour.
